(19) United States
(12) Patent Application Publication
(10) Pub. No.: US 2018/0335894 A1
(43) Pub. Date: Nov. 22, 2018

(54) MESSAGING AND ORCHESTRATING PLATFORM IN A COMPUTER NETWORK ENVIRONMENT

(71) Applicant: Cisco Technology, Inc., San Jose, CA (US)

(72) Inventors: Brian Sarbin, Santa Clara, CA (US); Daniel Garrison, San Jose, CA (US); Joseph Sutton, San Jose, CA (US)

(21) Appl. No.: 15/596,430

(22) Filed: May 16, 2017

(51) Int. Cl. G06F 3/0481; H04L 12/58

(52) U.S. Cl. CPC G06F 3/0481; H04L 51/22

(57) ABSTRACT

Disclosed is a graphical user interface for a messaging and orchestrating platform. The graphical user interface can include a first region of the graphical user interface that represents a topology of a network environment including one or more devices and one or more applications and a second region of the graphical user interface that represents a messaging platform for communicating with one or more members and the one or more devices and the one or more applications.

### TECHNICAL FIELD

The present technology pertains to a messaging and orchestrating platform for a plurality of different device types and more specifically to messaging channels for a plurality of the different devices for orchestrating control of the plurality of devices.

### BACKGROUND

Many networked environments (cloud and/or hybrid) are moving towards virtualizing components and infrastructure. The tools for interacting with the components are either a traditional physical device approach or fully cloud-based “virtual” approach. These networked environments now require a combination of these approaches, while providing visibility and centralized control for combining deployment tasks of the physical and virtualized components and infrastructure in the networked environment.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed is a graphical user interface for a messaging and orchestrating platform including a first region of the graphical user interface that represents a topology of a network environment including a map of a physical location and one or more devices and one or more applications and a second region of the graphical user interface that represents a messaging platform for communicating with one or more members and the one or more devices and the one or more applications.

In some examples, the second region can further include an input region for receiving input from the one or more members. The second region can further represent displaying and transmitting commands received from the one or more members to the one or more devices or applications. The second region further represents displaying responses from the one or more devices or applications in response to the commands.

In some examples, the first region further represents displaying graphical responses to the one or more devices or applications in response to the commands. The first region can be automatically updated to reflect changes to the one or more devices and applications.

In some examples, the graphical user interface can include a third region that represents a workflow summary of a deployed workflow. The one or more devices and applications of the first region can be associated with the deployed workflow. The third region can be automatically updated to reflect changes to the one or more devices and applications of the workflow summary.

Disclosed is a messaging and orchestrating platform including a server coupled to devices and applications, wherein each of the devices and applications include a set of commands for interaction and the server being configured to receive and transmit messages between members and the devices and the applications. The server can include a processor and a memory storing instructions, which when executed by the server cause the server to create a channel for communications between one or more of the devices, applications, and members, receive from a first member of the one or more members a first command for a first application of the one or more applications, transmit, to the channel, the first command, and receive, in response to the first command, a first message from the first application responding to the first command. In some examples, the first command can be to initiate a deployment of services of the application. The messaging and orchestrating platform can also receive from a second member of the one or more members a second command for the first application, transmit, to the channel, the second command, and receive, in response to the second command, a second message from the first application responding to the second command. In some examples, the second command can be to command the first application to perform an action. In some examples, the commands and messages can be displayed to the one or more members via a graphical user interface.

In some examples, the channel of the messaging and orchestrating platform can be created using application programming interfaces or agents. In some examples, messaging and orchestrating platform can include instructions which when executed by the processor causes the server to receive from a third member of the one or more members a third command for a second application, transmit, to the channel, the third command, and receive, in response to the third command, a third message from the second application responding to the third command. In some examples, the messaging and orchestrating platform can include further instructions which when executed by the processor causes the server to receive from the first member a fourth message for the second member, and transmit, to the channel, the fourth message.

Disclosed is a computer-implemented method for deploying applications and devices of a workflow. The method including deploying, at a server, a workflow including applications and devices, receiving, from one or more of the devices, an input, executing application-specific programming of one of the applications of the workflow, testing the application-specific programming, and in response to a successful test, deploying the one or more applications.

In some examples, the method can include determining, at the server, current and required states of the devices and the applications of the workflow, turning on and testing the one or more devices of the workflow and procuring, initiating and testing the one or more applications of the workflow. In some examples, the method can include testing the received input from the one or more devices. In some examples, the method can include receiving, from one or more members, commands for interacting with the devices and applications.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example network environment;

FIG. 2 illustrates an example network environment for testing and deploying services;

FIG. 3 illustrates an example messaging system for controlling testing and deploying services;

FIG. 4 illustrates an example network environment for testing and deploying services;

FIG. 5 illustrates a flow chart of an example method for deploying applications and devices in a network environment;

FIG. 6 shows an example of a system for implementing certain aspects of the present technology; and

FIG. 7 illustrates an example network device.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Disclosed is a system, method, and graphical user interface for deploying devices and applications in a networked environment. The devices and applications can be managed by one or more members through the graphical user interface. The graphical user interface can include a messaging system that connects devices, applications and members through application programming interfaces, agents or other ways of transmitting and receiving commands or instructions. The messaging system (e.g., instant messaging) can enable the members access to the devices and applications through APIs or a command line interface. As such, each member can control the devices and applications by sending commands to the devices through the messaging system. Each channel can include a bot for interfacing with the members and to facilitate communication among applications/devices and members. Bots and channels can be real constructs that exist in messaging platforms (e.g., Cisco Spark). For example, the members can issue commands, through the messaging system (e.g., via a command line interface), to the bot of an application or device. In response, the bot will execute the command on the application or device (e.g., via API, agent, etc.). The graphical user interface can also manage a workflow of a network environment (e.g., media production at a sporting event). During the execution of the workflow, the one more members can interface, through the messaging system, with the devices and applications to ensure the workflow is progressing to deployment.

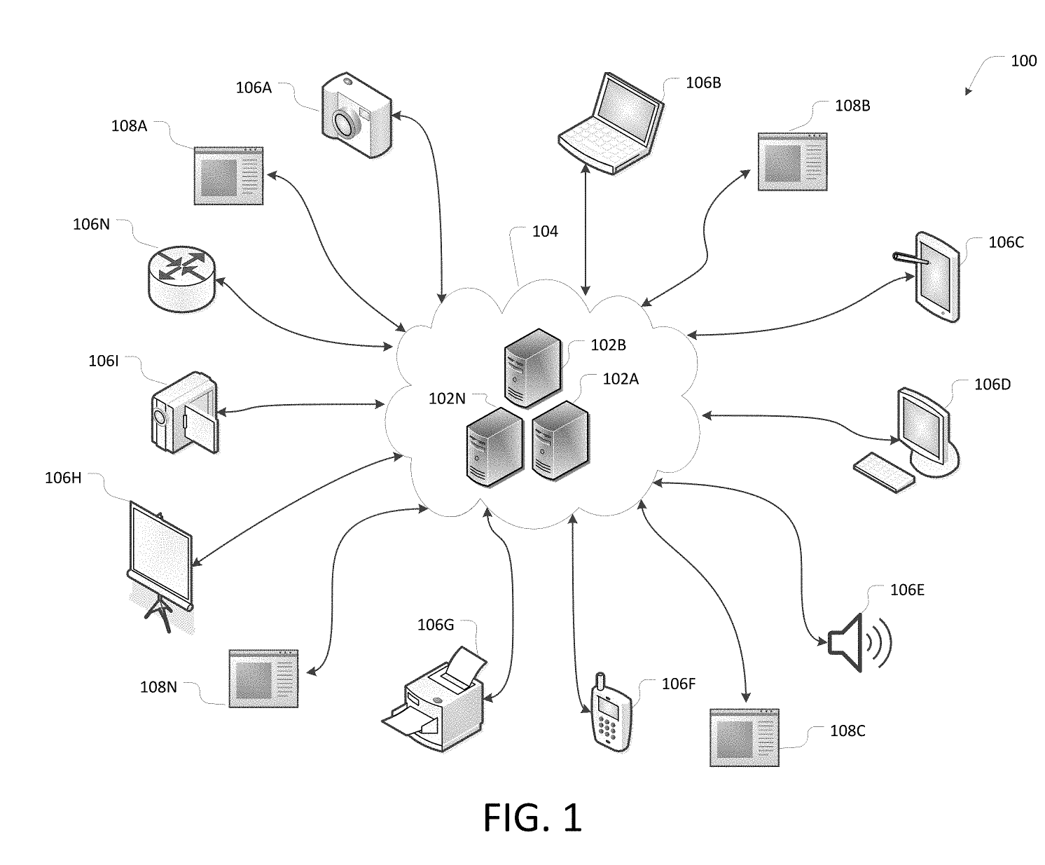

FIG. 1 illustrates an example of a networked environment 100, where electronic devices and applications communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network, cloud, hybrid cloud, etc.

In networked environment 100, servers 102A, 102B, . . . , 102N (collectively “102”) can be connected to network 104 by direct and/or indirect communication. Network 104 can be a variety of different networks, including, but not limited to: cloud-based network, hybrid cloud-based network, distributed network, WAN, Local Area Network (LAN), Virtual LAN (VLAN), the Internet, etc. Servers 102 can be a centralized system for orchestrating communication between a plurality of devices and applications. For examples, servers 102 can communication with devices 106A, 106B, 106C, 106D, 106E, 106F, 106G, 106H, . . . , 106N (collectively “106”) and applications 108A, 108B, 108C, . . . , 108N (collectively “108”). Communication between servers 102 and applications 108 (through network 104) can be through application programming interfaces (API), agents, secure shell (SSH), etc. Furthermore, servers 102 can concurrently accept connections and communications from and interact with multiple devices 106 and applications 108. In some examples, servers 102 include a single server. In other examples, servers 102 include one or more servers.

Devices 106 can include, but are not limited to: still image capturing device 106A, portable computer 106B, smartphone/tablet 106C, desktop computer 106D, audio input device 106E, mobile phone 106F, printer 106G, visual display device 106H, moving image capturing device 106I, and/or network device 106N. Devices 106 can be of varying type, capabilities, operating systems, etc. Applications 108 can include, but are not limited to: mobile applications, desktop applications, programs, suites, libraries, frameworks, messaging applications, web browsers, media players, application suites, enterprise software, information worker software, resource management software, simulation software, integrated development software, information technology software, etc.

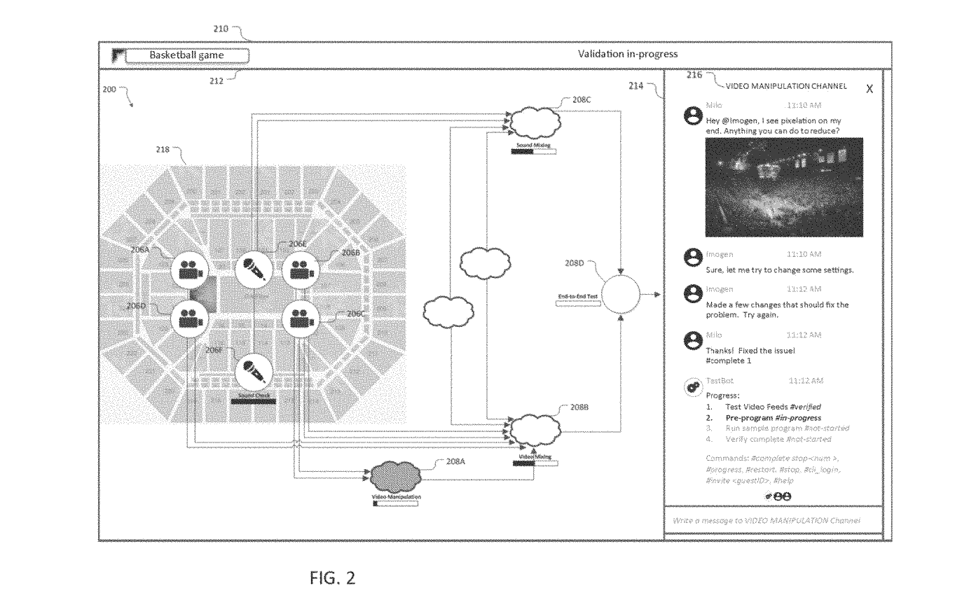

FIG. 2 illustrates a graphical user interface (GUI) 210 of an example network environment 200 for testing and deploying services. In some examples, GUI 210 can have a first region (200) and a second region (214). GUI 210 can provide a graphical representation of devices 206 (e.g., physical) and applications 208 (e.g., virtual) in the network environment 200. GUI 210 can also provide a selectable title 212 for selecting one or more network environment to display (e.g., sports venue, concert venue, etc.). GUI 210 can also include messaging pane 214 for displaying one or more channels 216. For example, a video manipulation channel can be visible in the GUI because the video manipulation component is selected from the topology. The channels can enable interaction between members (e.g., one or more concurrently) and the devices and applications (via APIs, agents, etc.). For example, an application can have an associated channel, the associated channel can enable a member access to a command line interface (e.g., to communicate with, control, provide instructions, etc.) to the one or more connected devices or applications. In some examples, a member can message all available channels. In some examples, a member can message individual or a combination of channels. In some examples, channels can automatically be grouped in subsets (e.g., by common themes, components, subcomponents—required to work together, categories, etc.). In some examples, where there is more than one channel, the member has access to a common set of commands (e.g., union of commands of the channels). In other examples, an identifier can be used with the command (e.g., @device12345<command>) for interacting with the specific device or application.

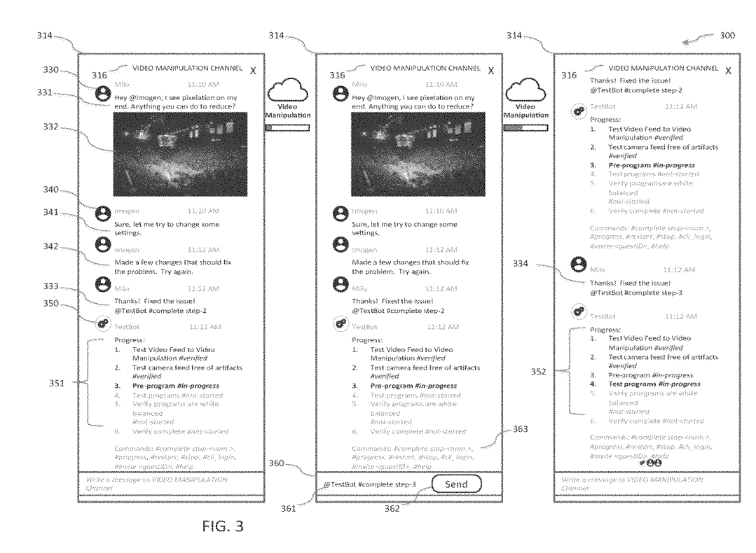

Network environment 200 displayed on GUI 210 can have a map 218. Map 218 can display the details of the physical area where the network environment 200 is deployed (e.g., Celtics basketball stadium, Australian Open, Six Flags Amusement Park, etc.). One or more devices 206 and applications 208 (e.g., shown as icons) can overlay map 218 to create a topology of the network environment. For example, network environment 200 can include video cameras 206A, 206B, 206C, 206D; audio input devices 206E and 206F; and video manipulation application 208A, video mixing application 208B, audio mixing application 208C, and end-to-end test application 208D. The GUI 210 can be automatically updated to reflect the current status of the devices and applications (e.g., progress bars, online/offline, etc.). The devices and applications displayed on GUI 210 can be selected. For example, when a member selects video manipulation application 208A, messaging pane 214 can display video manipulation channel 216. In some examples, a menu option can be provided upon selection of the device or application icons. For example, one or more command options can be provided (graphical options also available from the messaging pane, shown in further details in FIG. 3). In some examples, by selecting an icon (applications/devices 206/208) in network environment 200, messaging pane 214 can show a filtered view with commands that are specific to the selected icon (e.g., application/device) (e.g., rather than the commands for every application/device represented in network environment 200).

FIG. 3 is an example messaging system 300 for controlling testing and deploying services. FIG. 3 illustrates messaging pane 314. Messaging pane 314 can be integrated in GUI 208 or can be an independent messaging application. Messaging pane 314 can display one or more channels, for example, video manipulation channel 316 (associated with video manipulation application 208A). Messaging channel 316 can include one or more members (e.g., Milo 330, Imogen 340) and one or more bots (e.g., Testbot 350). The one or more members can be from different discrete vendors (e.g., applications, devices, etc.) working together. For example, Milo 330 can be a administrator of the network environment and Imogen 340 can be a vendor of video manipulation application 208A. In some examples, vendors of other applications (e.g., video mixing, audio mixing, etc.) can be included in the message system 300 for collaborative messaging. For example, Milo 330 and Imogen 340 can communicate to fix pixelated videos in the messaging channel 316, as shown by message 331, image 332, and messages 341, 342, 333. In some examples, members (e.g., Milo 330, Imogen 340, etc.) can have limited access (e.g., role-based security, level-based credentials, etc.). For example, members can have limited visibility (or access) to specific icons (or channels) shown in network environment 200 (e.g., limiting executable commands to a smaller subset in a channel to specific members).

The one or more bots can each be associated with an application (e.g., video manipulation application 208A, video mixing application 208B, audio mixing application 208C, end-to-end test application 208D, etc.). The bots can be running at servers 102, a device associated with the application, or another device or system coupled to the network environment. Each bot can have a set of discrete commands that are contextual to deployment of services (e.g., media production at a sporting event). The available commands can vary between the channels. In some examples, the commands can be executed by a member by initiating the bot (e.g., @TestBot). In other examples, the commands can be executed automatically by an application or device (e.g., based on timing, schedule, triggered event, etc.). The bots can post information about deployment tasks (e.g., Progress 351, 352). The information about deployment tasks can be provided automatically or by request of a member. For example, message 333 (e.g., @TestBot #complete step2) entered and executed by Milo 330 for verifying completion of a test.

Members can enter commands and/or messages to other members or bots in message input 360 and can transmit the commands and/or messages by send button 362 (or by the “enter” key). For example, Milo 330 can enter the command 361 (“@TestBot #complete step-3”) to command TestBot 350 to complete step-3 of the deployment service. TestBot can complete the command and proceed to step-4 and output information 352 confirming the command 361. Messaging channel 316 can also provide help 363 for available commands. For examples, help 363 can be a form of software documentation on formal standards and conventions on how to use different commands. Help 363 can be dependent and provided by the channel.

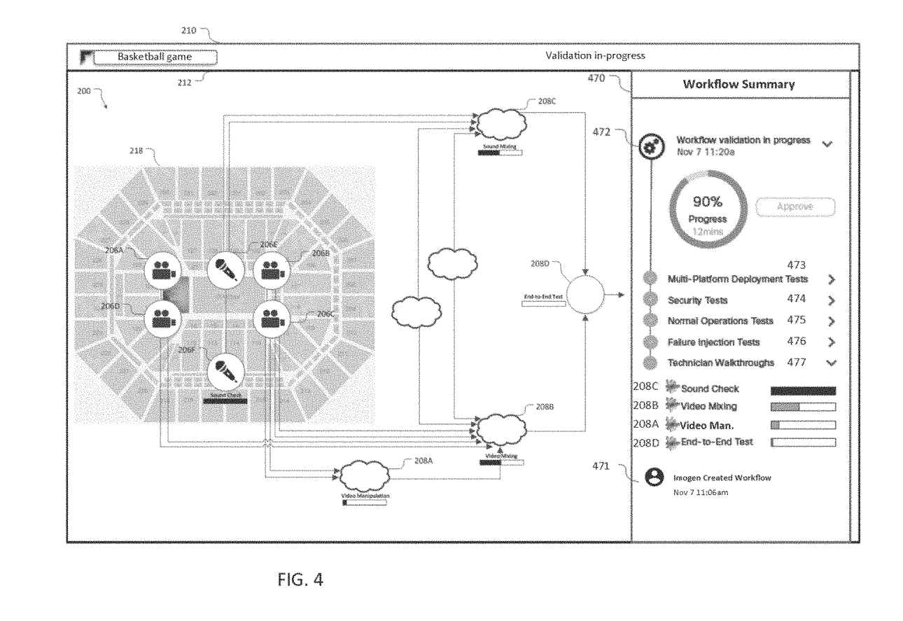

FIG. 4 illustrates a GUI 210 of an example network environment 400 for testing and deploying services with workflow summary 470. In some examples, workflow summary 470 can be shown when no icons (e.g., devices/applications) are selected (and no corresponding channels are shown). In other examples, workflow summary 470 can be shown when the user selects an alternative deployment view instead of a topological view (e.g., first region of the GUI can include visualizations beyond a network topology). Workflow summary 470 (e.g., third region) can include a graphical representation of the workflow for testing and deploying services. For example, a workflow can be created or initiated (e.g., 471) by a member (e.g., Imogen 340). Upon initiation workflow, validation 472 can be shown as “in progress” with a percentage completed (e.g., 90%) and time remaining (e.g., 12 minutes). In other examples, workflow validation can be initiated or completed. The workflow can show completed services (e.g., 473-476) and in-progress services (e.g., 477). The tasks can be further broken down into specific tasks (e.g., sound check 208C, video mixing 208B, video manipulation 208A, end-to-end testing 208D). The specific tasks can show a percentage completed (or progress bar).

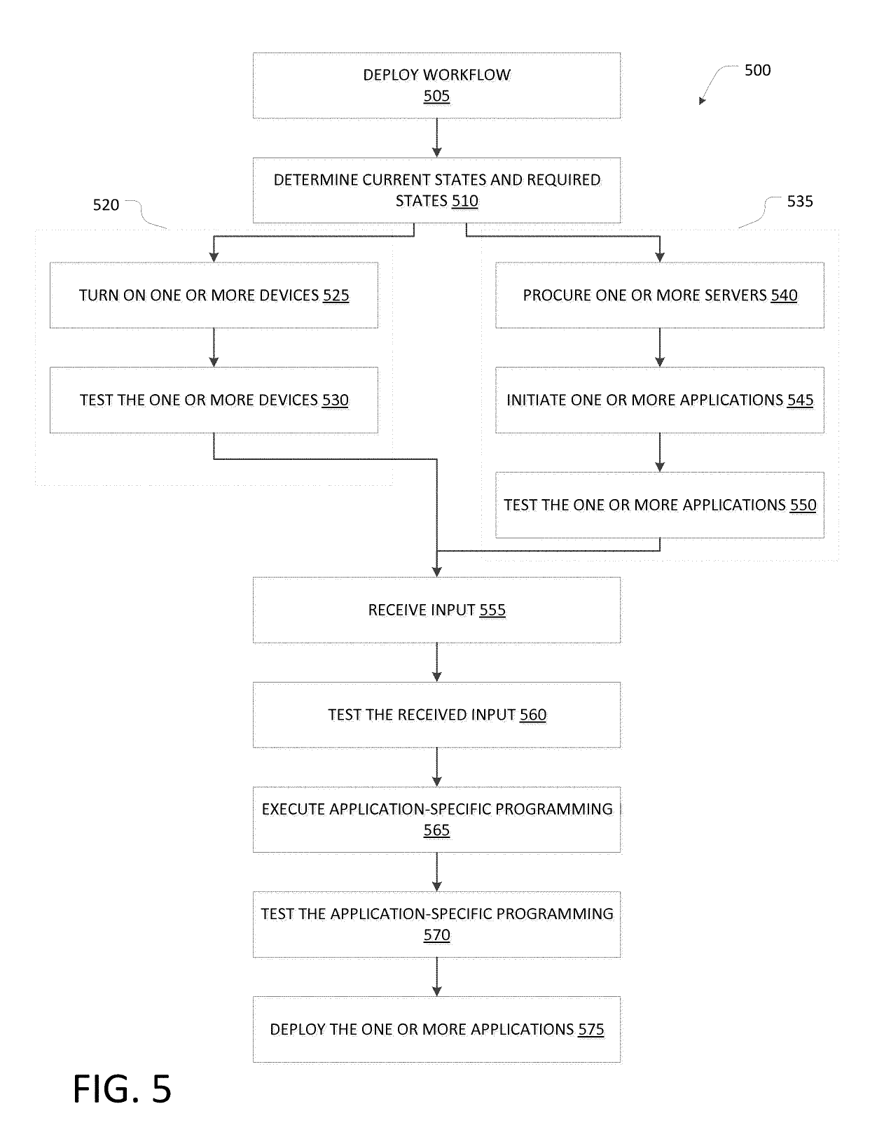

The method shown in FIG. 5 is provided by way of example, as there are a variety of ways to carry out the method. Additionally, while the example method is illustrated with a particular order of blocks, those of ordinary skill in the art will appreciate that FIG. 5 and the blocks shown therein can be executed in any order that accomplishes the technical advantages of the present disclosure and can include fewer or more blocks than illustrated.

Each block shown in FIG. 5 represents one or more processes, methods or subroutines, carried out in the example method. The blocks shown in FIG. 5 can be implemented in a network environment such as network environment 100 shown in FIG. 1. The flow chart illustrated in FIG. 5 will be described in relation to and make reference to at least the elements of system 100 shown in FIG. 1 and workflow and messaging interfaces of FIG. 2.

FIG. 5 shows a flow diagram of an example method 500 for testing and deploying services in a networked environment. Method 500 can begin at block 505. At block 505 a workflow can be initiated. For example, a media production of a sporting event as shown in FIG. 2. In some examples, the workflow can be deployed manually. In other examples, the workflow can be deployed automatically by servers 102. For example, based on a time schedule or triggering event (e.g., predetermined time before an event starts, etc.).

At block 510, current states and required states of devices and applications can be determined. For example, the workflow can include configuration settings and required states of devices and applications required for deploying services. The current state (e.g., on, off, active, deactivate, etc.) can be determined for the devices and applications (e.g., by API, agents, etc.). The required states can be included in the configuration settings.

Subsections 520 and 535 can be initiated and executed in parallel. At block 525, the devices can be activated. For example, moving image capture device 206 can be turned on. In some examples, servers 102 can send activation signals to one or more devices 104. In some examples, the services can send the signals when the current state of the devices does not match the required state from the configuration. When the devices are activated (e.g., turned on), the devices can be tested at block 530. In some examples, the test can be to determine if the device is online (e.g., ping, secure shell, etc.).

At block 540, one or more servers can be procured. For example, physical servers can be powered on or virtual servers can be instantiated. The number of servers (or virtual instances of servers) procured can be determined from the necessary computing power needed. In some examples, the number can be determined from the configuration settings. In other examples, the number can be determined from known usage of the device and applications (e.g., historical usage, etc.).

At block 545, one or more applications can be initiated. In some examples, one or more applications can be executed on the one or more servers. In other examples, one or more applications can be started as virtual machines on the one or more servers. For example, video manipulation application 208A can be initialized as a virtual machine on a server 102. When the one or more applications have been started (e.g. turned on and running), the applications can be tested at block 550. For example, the one or more applications can be tested by running a test suite (e.g., executing of general functionality of the application). In other examples, the one or more applications can be tested by API or agent.

At block 555, the one or more applications can receive input from the one or more devices. For example, video manipulation application 208A can receive one or more video feeds from moving image capture devices 206. In other examples, the one or more applications can receive audio, video, image, text, or any other kind of input captured by the devices.

At block 560, the received input can be tested. For example, video manipulation application 208A can test the received video feed. In some examples, the test can be artifact related (e.g., video/audio is free from distortion).

At block 565, the application can execute application-specific programming. For example, video manipulation application 208A can execute programming for manipulating the received video feed. In some examples, the manipulation can be adding content to the video stream (e.g., logo, banner, additional content, etc.). At block 570, the application-specific programming can be tested. For example, the manipulation of the received video feed can be tested. In some examples, the video manipulation application 208A can test if the video stream (with the additional content) is white balanced.

At block 575, the deployment testing can be completed and the one or more devices and applications can be deployed.

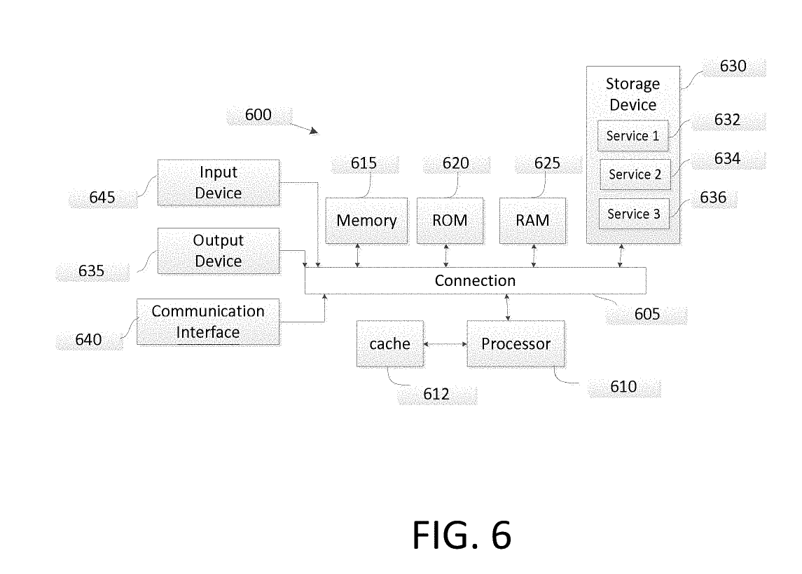

FIG. 6 shows an example of computing system 600 in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read only memory (ROM) and random access memory (RAM) to processor 610. Computing system 600 can include a cache of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

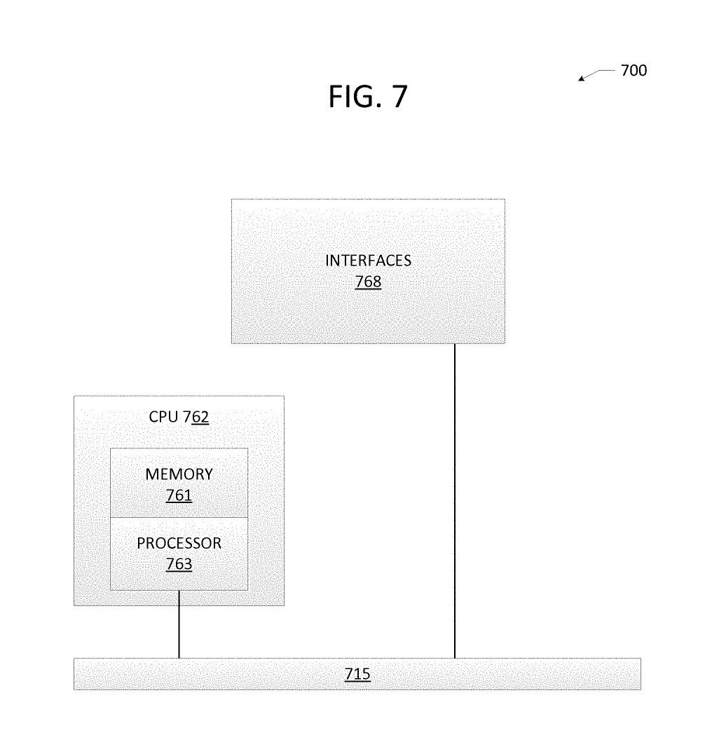

FIG. 7 illustrates an example network device 700 suitable for routing, switching, forwarding, traffic management, and load balancing. Network device 700 can be, for example, a router, a switch, a controller, a server, a gateway, and/or any other L2 and/or L3 device.

Network device 700 can include a master central processing unit (CPU) 762, interfaces 768, and a bus 715 (e.g., a PCI bus). When acting under the control of appropriate software or firmware, the CPU 762 is responsible for executing packet management, error detection, load balancing operations, and/or routing functions. The CPU 762 can accomplish all these functions under the control of software including an operating system and any appropriate applications software. CPU 762 may include one or more processors 763, such as a processor from the Motorola family of microprocessors or the MIPS family of microprocessors. In an alternative embodiment, processor 763 is specially designed hardware for controlling the operations of network device 700. In a specific embodiment, a memory 761 (such as non-volatile RAM and/or ROM) also forms part of CPU 762. However, there are many different ways in which memory could be coupled to the system.

The interfaces 768 are typically provided as interface cards (sometimes referred to as “line cards”). Generally, they control the sending and receiving of data packets over the network and sometimes support other peripherals used with the network device 700. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 762 to efficiently perform routing computations, network diagnostics, security functions, etc.

Although the system shown in FIG. 7 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 761) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A graphical user interface for a messaging and orchestrating platform comprising:
a first region of the graphical user interface configured to display a topology of a network environment including one or more devices and one or more applications; and
a second region of the graphical user interface configured to display a messaging platform for communicating with one or more members and the one or more devices and the one or more applications.

2. The graphical user interface of claim 1, wherein the second region further comprising an input region for receiving input from the one or more members.

3. The graphical user interface of claim 2, wherein the second region further configured to display and transmit commands received from the one or more members to the one or more devices or applications.

4. The graphical user interface of claim 3, wherein the second region further configured to display responses from the one or more devices or applications in response to the commands.

5. The graphical user interface of claim 3, wherein the first region further configured to display graphical responses to the one or more devices or applications in response to the commands.

6. The graphical user interface of claim 1, wherein the first region is automatically updated to reflect changes to the one or more devices and applications.

7. The graphical user interface of claim 1, further comprising:
a third region of the graphical user interface configured to display a workflow summary of a deployed workflow.

8. The graphical user interface of claim 7, wherein the one or more devices and applications of the first region are associated with the deployed workflow.

9. The graphical user interface of claim 8, wherein the third region is automatically updated to reflect changes to the one or more devices and applications of the workflow summary.

10. A messaging and orchestrating platform comprising:
a server coupled to one or more devices and to one or more applications, wherein each of the devices and applications include a set of commands for interaction and the server being configured to receive and transmit messages between one or more members and the devices and the applications;
the server comprising a processor and a memory storing instructions, which when executed by the server cause the server to:
create a channel for communications between one or more of the devices, applications, and members;
receive from a first member of the one or more members a first command for a first application of the one or more applications;
transmit, to the channel, the first command;
receive, in response to the first command, a first message from the first application responding to the first command;
receive from a second member of the one or more members a second command for the first application;
transmit, to the channel, the second command; and
receive, in response to the second command, a second message from the first application responding to the second command.

11. The messaging and orchestrating platform of claim 10, wherein the channel is created using application programming interfaces or agents.

12. The messaging and orchestrating platform of claim 10, wherein the first command is to initiate a deployment of services of the application.

13. The messaging and orchestrating platform of claim 10, wherein the second command is to command the first application to perform an action.

14. The messaging and orchestrating platform of claim 10, further comprising instructions which when executed by the processor causes the server to:
receive from a third member of the one or more members a third command for a second application;
transmit, to the channel, the third command; and
receive, in response to the third command, a third message from the second application responding to the third command.

15. The messaging and orchestrating platform of claim 10, further comprising instructions which when executed by the processor causes the server to:
receive from the first member a fourth message for the second member; and
transmit, to the channel, the fourth message.

16. The messaging and orchestrating platform of claim 10, wherein the commands and messages are displayed to the one or more members via a graphical user interface.

17. A computer-implemented method comprising:
deploying, at a server, a workflow including applications and devices;
receiving, from one or more of the devices, an input;
executing application-specific programming of one of the application of the workflow;
testing the application-specific programming; and
in response to a successful test, deploying the one or more applications.

18. The computer-implemented method of claim 17, further comprising:
determining, at the server, current and required states of the devices and the applications of the workflow;
turning on and testing the one or more devices of the workflow;
procuring, initiating and testing the one or more applications of the workflow;

19. The computer-implemented method of claim 17, further comprising testing the received input from the one or more devices.

20. The computer-implemented method of claim 17, further comprising:
receiving, from one or more members, commands for interacting with the devices and applications.
